(19) United States
(12) Patent Application Publication
(10) Pub. No.: US 2019/0120390 A1
(43) Pub. Date: Apr. 25, 2019

(54) Cartridge Assembly for Regulating Flows

(71) Applicant: Hector Hernandez, Santa Clarita, CA (US)

(72) Inventor: Hector Hernandez, Santa Clarita, CA (US)

(21) Appl. No.: 15/789,982

(22) Filed: Oct. 21, 2017

(51) Int. Cl. F16K 3/08; E03C 1/04; F16K 11/00

(52) U.S. Cl. CPC F16K 3/085; F16K 19/006; E03C 1/0403

(57) ABSTRACT

The present invention provides a cartridge assembly for a faucet. The cartridge assembly permits flows from a first flow source and a second flow source to flow through the cartridge assembly and to be regulated through the faucet without permitting flows from the two sources to flow simultaneously through the cartridge assembly.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Water-filtering systems for the home fall under two basic categories: Point of Entry (POE) and Point of Use (POU). A POE system filters water as it enters the home, providing filtered water to every faucet and water outlet fixture. A POU system filters water at a specific faucet or water outlet fixture in the home, providing filtered water only at that specific location. One popular location for installing a POU system in the home is under the kitchen sink. A dedicated faucet to dispense filtered water from this type of system is usually necessary and can be fitted through an available opening in the sink usually reserved for a liquid soap dispenser. Where a dedicated faucet is not necessary, the POU system requires a separate control apparatus with a control unit fitted through the sink opening to switch between dispensing cold water and filtered water through the existing faucet. Installation of a POU system at other locations within the home, such as under a bathroom sink, although possible, is not typical. One reason for this may be the additional effort required to drill a hole through the bathroom sink or to replace the sink with one having a pre-drilled hole, since most bathroom sinks do not typically have an existing hole for a liquid soap dispenser. Another reason may be due to aesthetics. A separate dispensing faucet or control unit may detract from the desired appearance of the bathroom decor if it does not match the style of the existing bathroom faucet.

### BRIEF SUMMARY OF THE INVENTION

The present invention provides a cartridge assembly for a faucet. The cartridge assembly permits flows from a first flow source (such as a cold-water source) and a second flow source (such as a filtered-water source) to flow through the cartridge assembly and to be regulated through the faucet without permitting flows from the two sources to flow simultaneously through the cartridge assembly. With the present invention, filtered water from a POU system may be dispensed from the same faucet that dispenses domestic cold and hot water, without the need for a separate, dedicated faucet or control unit to dispense the filtered water.

In an exemplary embodiment of the present invention, a cartridge assembly for a right-hand installation in a two-handle faucet shall be described. The cartridge assembly includes a cartridge shell. The cartridge shell includes two openings, a first opening and a second opening. The cartridge assembly includes a stem. The stem is operable to be at least partially disposed within the cartridge shell. The cartridge assembly includes a moveable disk. The moveable disk is operable to be disposed within the cartridge shell. The moveable disk includes one opening. The cartridge assembly includes a fixed disk. The fixed disk is operable to be disposed within the cartridge shell. The fixed disk includes two openings, a first opening and a second opening.

In the exemplary embodiment of the present invention, the moveable disk abuts the fixed disk. The stem is operable to be connected to the moveable disk so that rotation of the stem causes rotation of the moveable disk relative to the fixed disk. Flow through the cartridge assembly either flows through the first opening in the fixed disk and through the opening in the moveable disk and exits through the first opening in the cartridge shell or flows through the second opening in the fixed disk and through the opening in the moveable disk and exits through the second opening in the cartridge shell.

In the exemplary embodiment of the present invention, the moveable disk and the fixed disk are configured such that movement of the moveable disk relative to the fixed disk creates a first zone of control and a second zone of control. Under the first zone of control, a flow of cold water is regulated through a range of stem rotation from a completely-closed position, which does not permit any flow of the cold water through the cartridge assembly, to a completely-open position at a clockwise rotation of the stem of ninety degrees (90°), which permits a maximum flow of the cold water through the cartridge assembly. Under the second zone of control, a flow of filtered water is regulated through a range of stem rotation from a completely-closed position, which does not permit any flow of the filtered water through the cartridge assembly, to a completely-open position at a counterclockwise rotation of the stem of ninety degrees (90°), which permits a maximum flow of the filtered water through the cartridge assembly. Under the first zone of control, the flow of cold water is regulated through the cartridge assembly from the cold-water source through the first opening in the fixed disk and through the opening in the moveable disk and through the first opening in the cartridge shell. Under the second zone of control, the flow of filtered water is regulated through the cartridge assembly from the filtered-water source through the second opening in the fixed disk and through the opening in the moveable disk and through the second opening in the cartridge shell.

### BRIEF DESCRIPTION OF THE SEVERAL VIEWS OF THE DRAWINGS

FIG. 1 is a perspective view of a cartridge assembly installed in a valve body according to an exemplary embodiment of the present invention;

FIG. 2 is an exploded perspective view of the cartridge assembly of FIG. 1;

FIG. 3 is a bottom plan view of the cartridge assembly of FIG. 2;

FIG. 4 is a cross-sectional view of the cartridge assembly of FIG. 3 along the line 4-4, rotated clockwise ninety degrees (90°);

FIGS. 5A-5D are views of the base seal of FIG. 2-FIG. 5A is a top plan view, FIG. 5B is a bottom plan view, FIG. 5C is a front elevational view, and FIG. 5D is a side elevational view;

FIGS. 6A-6D are views of the moveable disk of FIG. 2-FIG. 6A is a top plan view, FIG. 6B is a bottom plan view, FIG. 6C is a front elevational view, and FIG. 6D is a side elevational view;

FIGS. 7A-7D are views of the fixed disk of FIG. 2-FIG. 7A is a top plan view, FIG. 7B is a bottom plan view, FIG. 7C is a front elevational view, and FIG. 7D is a side elevational view;

FIGS. 8A-8C are top plan views of the moveable disk of FIG. 2 in operable relation to the fixed disk of FIG. 2-FIG. 8A is a view of the moveable disk and the fixed disk in a completely-closed position, FIG. 8B is a view of the moveable disk and the fixed disk in a completely-open position at ninety degrees (90°) clockwise rotation of the moveable disk relative to the fixed disk; and FIG. 8C is a view of the moveable disk and the fixed disk in a completely-open position at ninety degrees (90°) counterclockwise rotation of the moveable disk relative to the fixed disk.

### DETAILED DESCRIPTION OF THE INVENTION

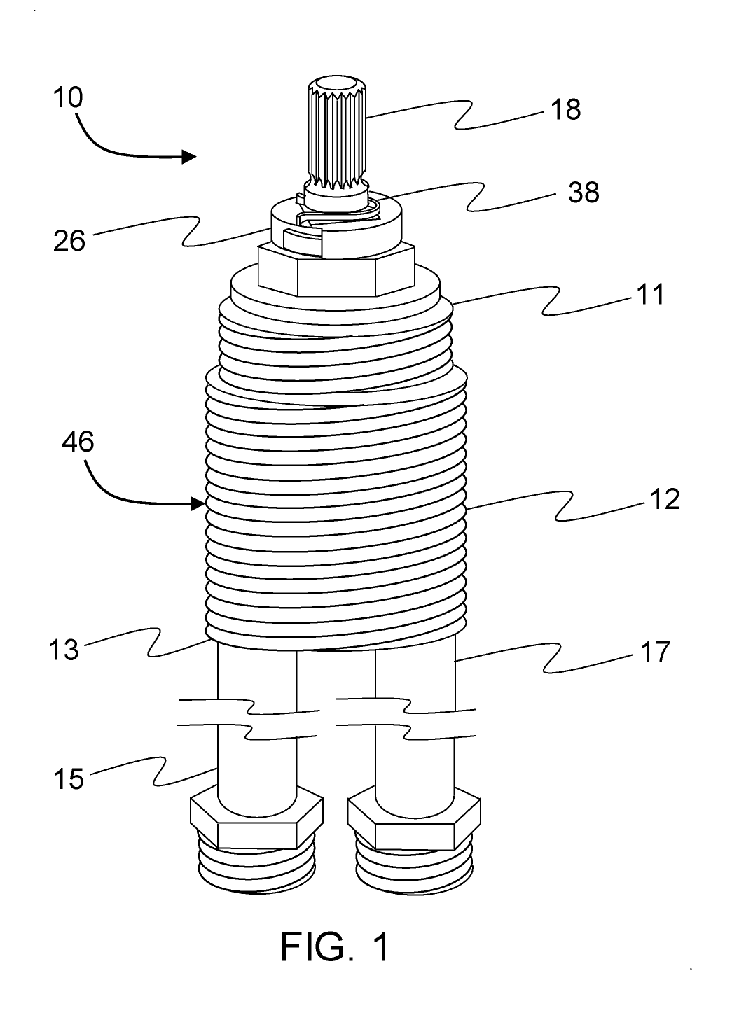

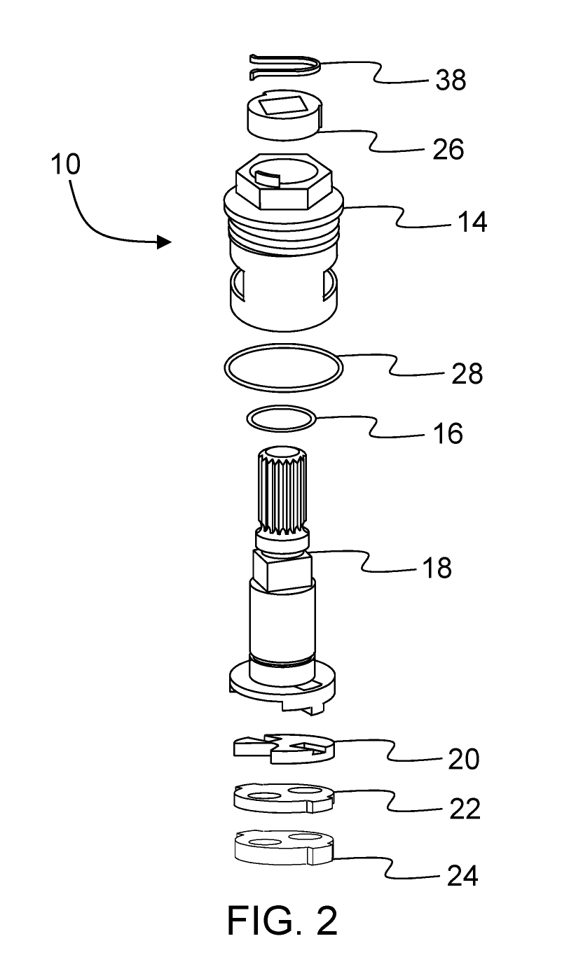

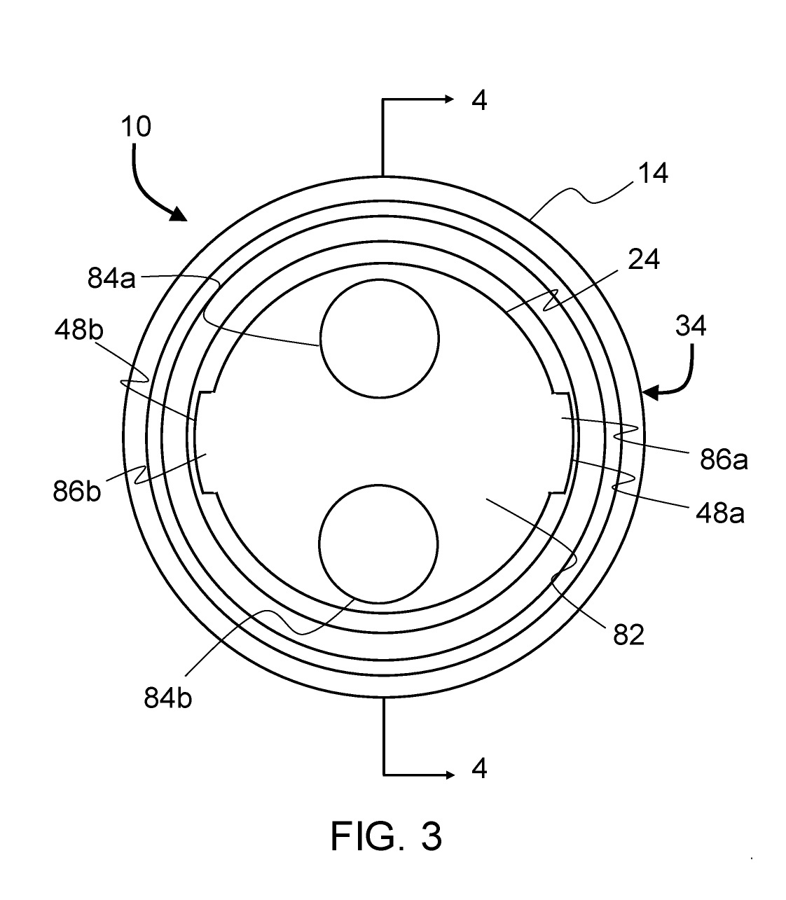

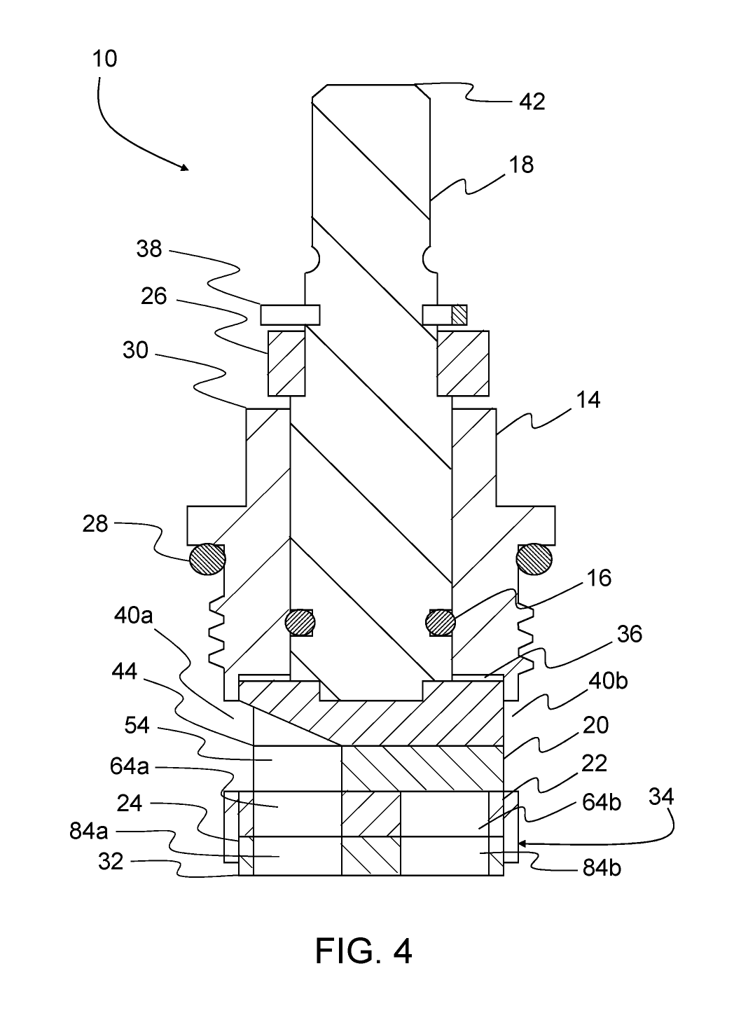

An exemplary embodiment of a cartridge assembly 10 of the present invention for a right-hand installation of a two-handle faucet is shown in FIGS. 1-4. As illustrated in FIG. 1, the cartridge assembly 10 is installed in a valve body 12. As illustrated in FIGS. 2 and 4, the cartridge assembly 10 includes a cartridge shell 14, a stem 18, a stem seal 16, a stem collar 26, a retaining clip 38, a moveable disk 20, a fixed disk 22, a base seal 24, and a cartridge shell seal 28. Cartridge assemblies and valve bodies are well known in the art; therefore, only the relevant components of the cartridge assembly 10 and the valve body 12 will be described in greater detail.

In the exemplary embodiment, as illustrated in FIG. 4, the cartridge shell 14 includes a first end 30 and a second end 32. The cartridge shell 14 has an exterior surface 34 with a generally cylindrical shape. The cartridge shell 14 has an interior 36. The cartridge shell 14 includes a first opening 40a and a second opening 40b, both openings extending from the interior 36 through the exterior surface 34 between the first end 30 and the second end 32 of the cartridge shell 14. Additionally, the cartridge shell 14 includes two recesses 48a, 48b arranged one hundred eighty degrees (180°) apart on the inner periphery of the cartridge shell 14, as shown in FIG. 3. The cartridge shell 14 can be formed of plastic, metal, or any other suitable material.

In the exemplary embodiment, as illustrated in FIG. 1, the valve body 12 includes a first end 11 and a second end 13. The valve body 12 includes a first inlet tube 15 and a second inlet tube 17. The inlet tubes 15, 17 are connected to the second end 13 of the valve body 12. The valve body 12 has an exterior surface 46 with a generally cylindrical shape. The valve body 12 has an interior surface (not shown) with a generally cylindrical shape. The interior surface of the valve body 12 generally corresponds to the exterior surface 34 of the cartridge shell 14. The valve body 12 can be formed of plastic, metal, or any other suitable material.

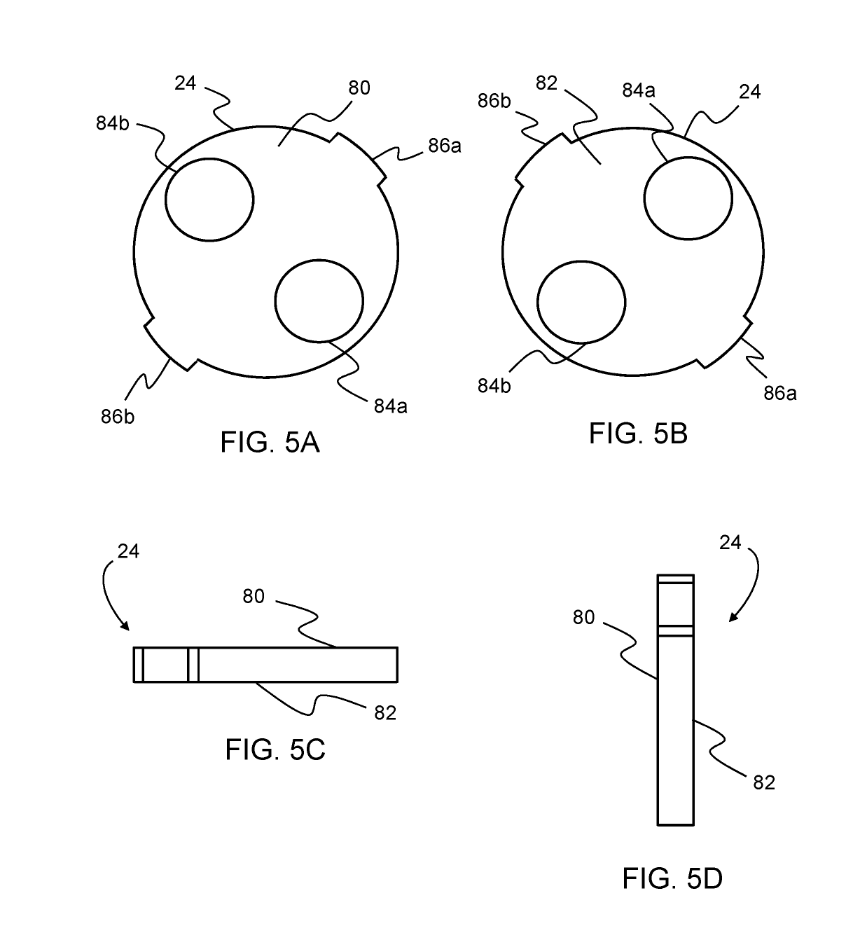

In the exemplary embodiment, as illustrated in FIGS. 3 and 5A-5D, the base seal 24 includes a top side 80 and a bottom side 82. The base seal 24 includes a first opening 84a extending from the top side 80 through the bottom side 82. The base seal 24 includes a second opening 84b extending from the top side 80 through the bottom side 82. Additionally, the base seal 24 includes two lugs 86a, 86b arranged one hundred eighty degrees (180°) apart on the periphery of the base seal 24 for engagement with the recesses 48a, 48b on the inner periphery of the cartridge shell 14. The base seal 24 can be formed of neoprene or any other suitable material.

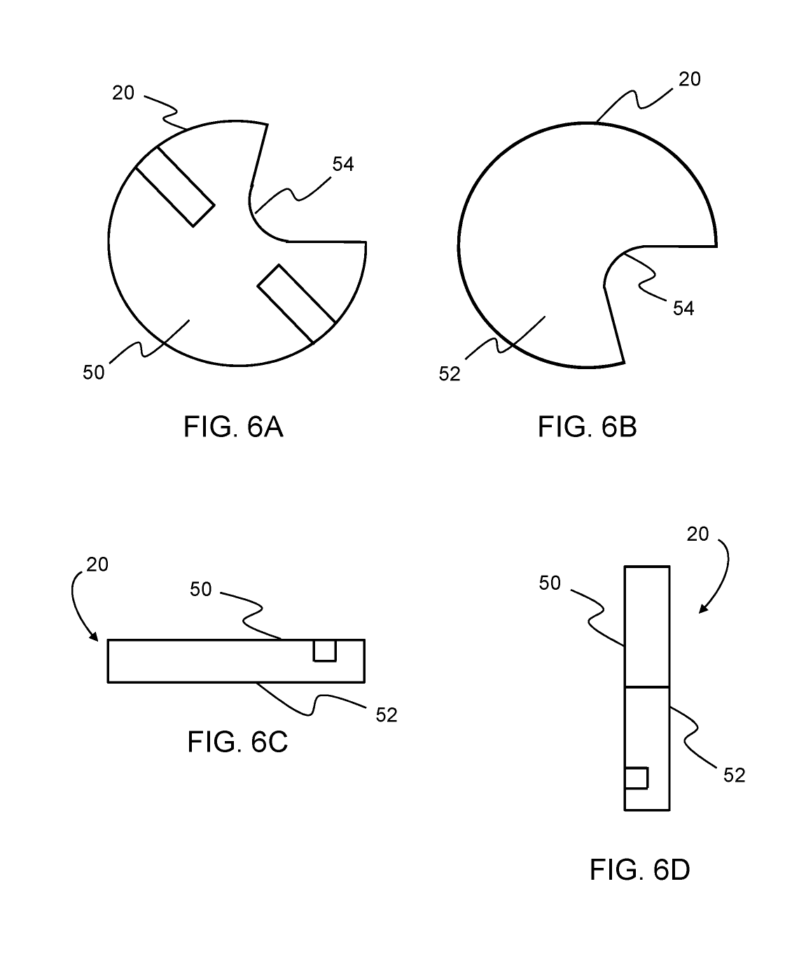

In the exemplary embodiment, as illustrated in FIGS. 6A-6D, the moveable disk 20 includes a top side 50 and a bottom side 52. The moveable disk 20 includes one opening 54 extending from the top side 50 through the bottom side 52. The opening 54 is configured such that the moveable disk 20 presents an open-mouth shape when viewed in plan view, as illustrated in FIGS. 6A and 6B. The moveable disk 20 can be formed of ceramic material or any other suitable material.

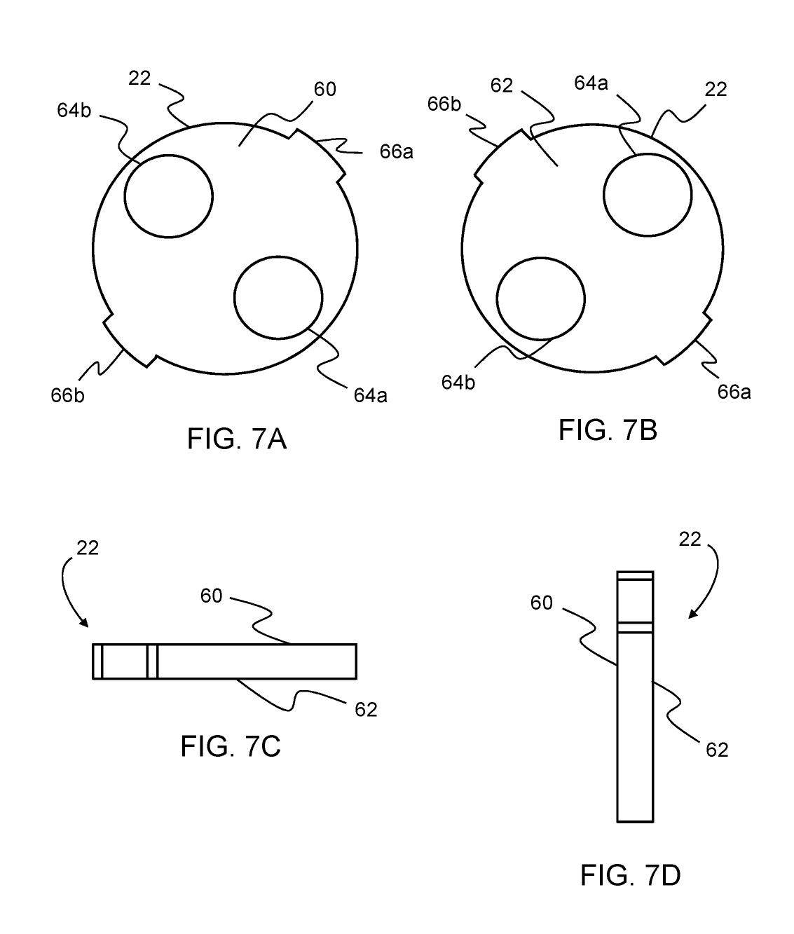

In the exemplary embodiment, as illustrated in FIGS. 7A-7D, the fixed disk 22 includes a top side 60 and a bottom side 62. The fixed disk 22 includes a first opening 64a extending from the top side 60 through the bottom side 62. The fixed disk 22 includes a second opening 64b extending from the top side 60 through the bottom side 62. Additionally, the fixed disk 22 includes two lugs 66a, 66b arranged one hundred eighty degrees (180°) apart on the periphery of the fixed disk 22 for engagement with the recesses 48a, 48b on the inner periphery of the cartridge shell 14. The fixed disk 22 can be formed of ceramic material or any other suitable material.

In the exemplary embodiment, as illustrated in FIG. 4, the stem 18 includes a first end 42 and a second end 44. A handle (not shown) is connected to the first end 42 of the stem 18. The second end 44 of the stem 18 is operably connected to the top side 50 of the moveable disk 20. The bottom side 52 of the moveable disk 20 abuts the top side 60 of the fixed disk 22. The bottom side 62 of the fixed disk 22 abuts the top side 80 of the base seal 24. The first opening 84a in the base seal 24 is aligned with the first opening 64a in the fixed disk 22. The second opening 84b in the base seal 24 is aligned with the second opening 64b in the fixed disk 22.

In the exemplary embodiment, a cold-water source is connected to the first inlet tube 15 of the valve body 12. The first inlet tube 15 abuts the first opening 84A in the base seal 24. A filtered-water source is connected to the second inlet tube 17 of the valve body 12. The second inlet tube 17 abuts the second opening 84B in the base seal 24. Rotation of the handle causes rotation of the stem 18. Rotation of the stem 18 causes rotation of the moveable disk 20. Rotation of the moveable disk 20 relative to the fixed disk 22 permits either cold water from the first inlet tube 15 or filtered water from the second inlet tube 17 to flow through the cartridge assembly 10 but does not permit the cold water and the filtered water to flow simultaneously through the cartridge assembly 10.

In the exemplary embodiment, as illustrated in FIG. 4, clockwise rotation of the handle causes the opening 54 in the moveable disk 20 to overlap the first opening 64a in the fixed disk 22. The cold water entering the first opening 84a in the base seal 24 flows through the first opening 64a in the fixed disk 22 then flows through the opening 54 in the moveable disk 20. The cold water then exits through the first opening 40a in the cartridge shell 14. Counterclockwise rotation of the handle causes the opening 54 in the moveable disk 20 to overlap the second opening 64b in the fixed disk 22. The filtered water entering the second opening 84b in the base seal 24 flows through the second opening 64b in the fixed disk 22 then flows through the opening 54 in the moveable disk 20. The filtered water then exits through the second opening 40b in the cartridge shell 14.

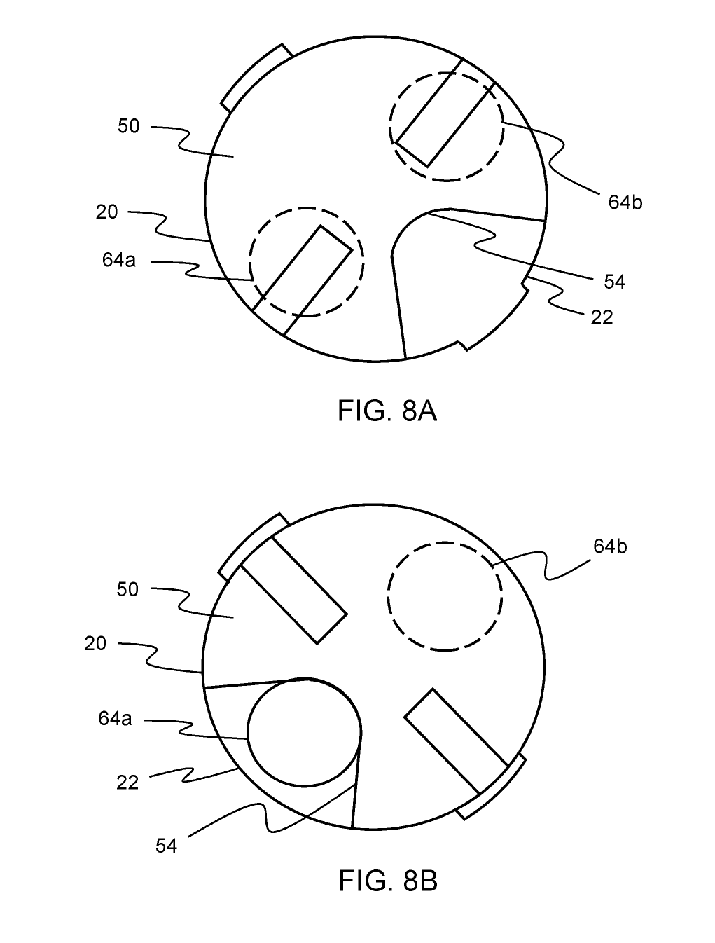

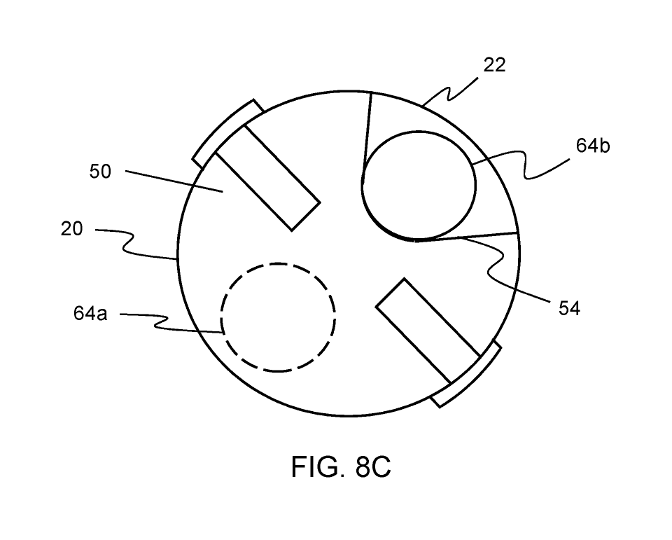

In the exemplary embodiment, as illustrated in FIG. 8A, when the handle and the stem 18 are in a completely-closed position, the opening 54 in the moveable disk 20 does not align with either the first opening 64a or the second opening 64b in the fixed disk 22 nor does the opening 54 in the moveable disk 20 overlap either the first opening 64a or the second opening 64b in the fixed disk 22. In the completely-closed position, the handle, stem 18, and moveable disk 20 are at zero degrees (0°) of rotation. As the handle and the stem 18 are rotated in a clockwise direction from the completely-closed position, the opening 54 in the moveable disk 20 begins to overlap the first opening 64a in the fixed disk 22. As the handle and the stem 18 are further rotated, the amount of overlap increases. When the handle and the stem 18 are rotated to a completely-open position at a handle and stem 18 rotation of approximately ninety degrees (90°) in the clockwise direction, the opening 54 in the moveable disk 20 is aligned with the first opening 64a in the fixed disk 22, as illustrated in FIG. 8B.

In the exemplary embodiment, as the handle and the stem 18 are rotated in a counterclockwise direction from the completely-closed position, the opening 54 in the moveable disk 20 begins to overlap the second opening 64b in the fixed disk 22. As the handle and the stem 18 are further rotated, the amount of overlap increases. When the handle and the stem 18 are rotated to a completely-open position at a handle and stem 18 rotation of approximately ninety degrees (90°) in the counterclockwise direction, the opening 54 in the moveable disk 20 is aligned with the second opening 64b in the fixed disk 22, as illustrated in FIG. 8C.

In the exemplary embodiment, the moveable disk 20 and the fixed disk 22 are configured to create two (2) zones of control for flows through the cartridge assembly 10. Under the first zone of control, the flow of cold water is regulated through a range of stem 18 rotation from the completely-closed position to a completely-open position at the clockwise rotation of the stem 18 of ninety degrees (90°). The first zone of control regulates the cold water through the first opening 64a in the fixed disk 22 and through the opening 54 in the moveable disk 20 and through the first opening 40a in the cartridge shell 14. Under the second zone of control, the flow of filtered water is regulated through a range of stem 18 rotation from the completely-closed position to a completely-open position at the counterclockwise rotation of the stem 18 of ninety degrees (90°). The second zone of control regulates the filtered water through the second opening 64b in the fixed disk 22 and through the opening 54 in the moveable disk 20 and through the second opening 40b in the cartridge shell 14.

One of ordinary skill in the art will now appreciate that the present invention provides a cartridge assembly for a faucet. The cartridge assembly permits flows from a first flow source and a second flow source to flow through the cartridge assembly and to be regulated through the faucet without permitting flows from the two sources to flow simultaneously through the cartridge assembly. Although the present invention has been shown and described with reference to a particular embodiment, equivalent alterations and modifications are within the scope of the present invention. The present invention is limited only by the scope of the following claims in light of their full scope of equivalent alterations and modifications.

I claim:

1. A cartridge assembly for a faucet, the cartridge assembly comprising:
a cartridge shell, the cartridge shell including a first end and a second end, the cartridge shell having an exterior surface, the cartridge shell having an interior, the cartridge shell including at least one opening extending from the interior through the exterior surface between the first end and the second end;
a stem, the stem operable to be at least partially disposed within the cartridge shell;
a moveable disk, the moveable disk operable to be disposed within the cartridge shell;
and a fixed disk, the fixed disk operable to be disposed within the cartridge shell;
wherein flows through the cartridge assembly flow through one end of the cartridge shell and exit through at least one opening in the cartridge shell;
wherein the moveable disk is operable to abut the fixed disk;
wherein the stem is operably connected to the moveable disk so that movement of the stem causes movement of the moveable disk relative to the fixed disk;
wherein the moveable disk and the fixed disk are configured such that movement of the moveable disk relative to the fixed disk creates zones of control;
wherein a first zone of control regulates flow from a first flow source through a range of movement of the stem from a completely-closed position, which does not permit any flow from the first flow source through the cartridge assembly, to a completely-open position, which permits a maximum flow from the first flow source through the cartridge assembly;
wherein a second zone of control regulates flow from a second flow source through a range of stem movement from a completely-closed position, which does not permit flow from the second flow source through the cartridge assembly, to a completely-open position, which permits a maximum flow from the second flow source through the cartridge assembly; and
wherein the moveable disk and the fixed disk are further configured such that movement of the moveable disk relative to the fixed disk does not permit flow from the first flow source and flow from the second flow source to be regulated simultaneously through the cartridge assembly.

2. The cartridge assembly of claim 1, wherein movement of the moveable disk relative to the fixed disk is rotational.

3. The cartridge assembly of claim 1, wherein the moveable disk is of generally circular shape, the moveable disk including a top side and a bottom side, the moveable disk including one opening extending from the top side through the bottom side.

4. The cartridge assembly of claim 3, wherein the opening of the moveable disk is configured such that the moveable disk presents an open-mouth shape when viewed in plan view.
